(19) United States
(12) Patent Application Publication
(10) Pub. No.: US 2014/0129533 A1
(43) Pub. Date: May 8, 2014

(54) INTERMEDIARY MODEL TO HANDLE WEB VOCABULARY CONFLICTS

(71) Applicant: MICROSOFT CORPORATION, Redmond, WA (US)

(72) Inventors: Jason Hogg, Kirkland, WA (US); Joshy Joseph, Redmond, WA (US)

(73) Assignee: MICROSOFT CORPORATION, Redmond, WA (US)

(21) Appl. No.: 13/672,645

(22) Filed: Nov. 8, 2012

(51) Int. Cl. G06F 17/30

(52) U.S. Cl. 707/705; 707/E17.001

(57) ABSTRACT

The subject disclose is directed towards a technology by which a semantic intermediary, such as a web service, translates web-content related metadata in one vocabulary/format to web-content related metadata in another vocabulary/format. A requesting client that receives a response containing the web-content related metadata in another vocabulary/format may then use the response to configure a web page or a Web service response containing the metadata in the other vocabulary/format.

### BACKGROUND

Semantic technologies, which essentially use metadata to describe meanings of data, content files, and/or application code, are evolving and being adopted for mainstream uses. In semantic web technology, vocabularies define the concepts and relationships used to describe and represent an area of concern or interest. As one example, with a web page, metadata in a vocabulary may be included in markup or the like that describes something about the content that is on the page, which helps search engines better understand the web page and thus provide better search results.

In general, vocabularies are used to classify the terms that can be used in a particular application, characterize possible relationships between terms, and define possible constraints on using those terms. Vocabularies help data integration when ambiguities may exist on the terms used in the different data sets, or when extra knowledge may lead to the discovery of new relationships. Vocabularies can be very complex (on the order of several thousands of terms) or very simple (describing one or two concepts only).

However no vocabularies are comprehensive. As a result, users are limited to using known vocabularies, or have to build their own vocabularies. Thus, implicitly or explicitly, most web sites use a vocabulary that is compliant with a standard, or alternatively is custom developed. This causes lot of fragmentation in the web.

Additionally, there are a complex set of semantic schemas and technologies that can be used to define the vocabularies and share data. For example, in the technical publication area there is large number of vocabularies including schema.org (associated with microdata), DITA (Darwin Information Typing Architecture), and custom ones such as TechNet.

As a result of the various vocabularies/schemas, search engines and other middleware may interpret data differently. For example, consider a user trying to collect “How-To” guidance on a specific topic from different websites. In one site the content type may be called “How-To” while in another site the content type may be called “Technical Article” or “KB” (knowledge base). Further, interpreting these sites' content/data becomes complex, e.g., one site may refer to the article's writer as the term “author”, whereas another may use the term “creator.” Results are delivered with different levels of accuracy depending on the query and internal algorithms used, and such results are not always predictable.

### SUMMARY

This Summary is provided to introduce a selection of representative concepts in a simplified form that are further described below in the Detailed

Description. This Summary is not intended to identify key features or essential features of the claimed subject matter, nor is it intended to be used in any way that would limit the scope of the claimed subject matter.

Briefly, various aspects of the subject matter described herein are directed towards a technology by which a request for semantic-related metadata in a second vocabulary is received, in which the request includes semantic-related metadata in a first vocabulary. The semantic-related metadata in the first vocabulary is translated to semantic-related metadata in the second vocabulary, which is returned in response to the request. In one implementation, the request may be received and processed at an intermediary web service.

In one aspect, a semantic intermediary may be configured to receive a request for data associated with one vocabulary, and to access mapping rules and a vocabulary collection to convert at least some of the data in the one vocabulary to data in another vocabulary. Data in the other vocabulary is returned in response to the request.

In one aspect, translation of web content-related metadata in one format to another format is requested. Upon receiving web content-related metadata in the other format in response to the request, the web content-related metadata in the other format is used to produce web-content related output. The web content-related metadata in the other format may be used to dynamically modify a web page for output.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram including components configured to provide an intermediary vocabulary service, according to one example embodiment.

FIG. 2 is a block diagram of an example translation of vocabularies, according to one example embodiment.

FIG. 3 is a block/dataflow diagram representing an example scenario in which a web page's metadata is dynamically modified based upon a response from a semantic intermediary, according to one example embodiment.

FIG. 4 is a flow diagram representing example steps that may be taken by a semantic intermediary to translate from one vocabulary to another, according to one example embodiment.

FIG. 5 is a block diagram representing an example computing environment, into which aspects of the subject matter described herein may be incorporated.

### DETAILED DESCRIPTION

Various aspects of the technology described herein are generally directed an intermediary, such as implemented as a web service, that manages vocabulary mapping and presents data in a format known to an end user. In one implementation, the intermediary understands a well-known set of vocabularies, applies a mapping (e.g., using a model) from one vocabulary to another, collects data from different sources, interprets the data based on vocabularies, acquires related data, converts data following the vocabulary relationships, and sends data back to users according to the vocabulary each user understands.

In one implementation, the intermediary stores or accesses known vocabularies, and uses an intermediary model to map from one vocabulary to another, with the knowledge to interpret the relationship between the terms used. The intermediary may retrieve data from multiple data providers and convert those data to new formats based on implied knowledge in the vocabulary mapping. The intermediary also may retrieve data from different data sources to fulfill the data relationship established in the vocabulary mapping. A technology mapping layer may be used to handle the set of semantic technologies and interpret the syntax and semantic to understand the data being exposed.

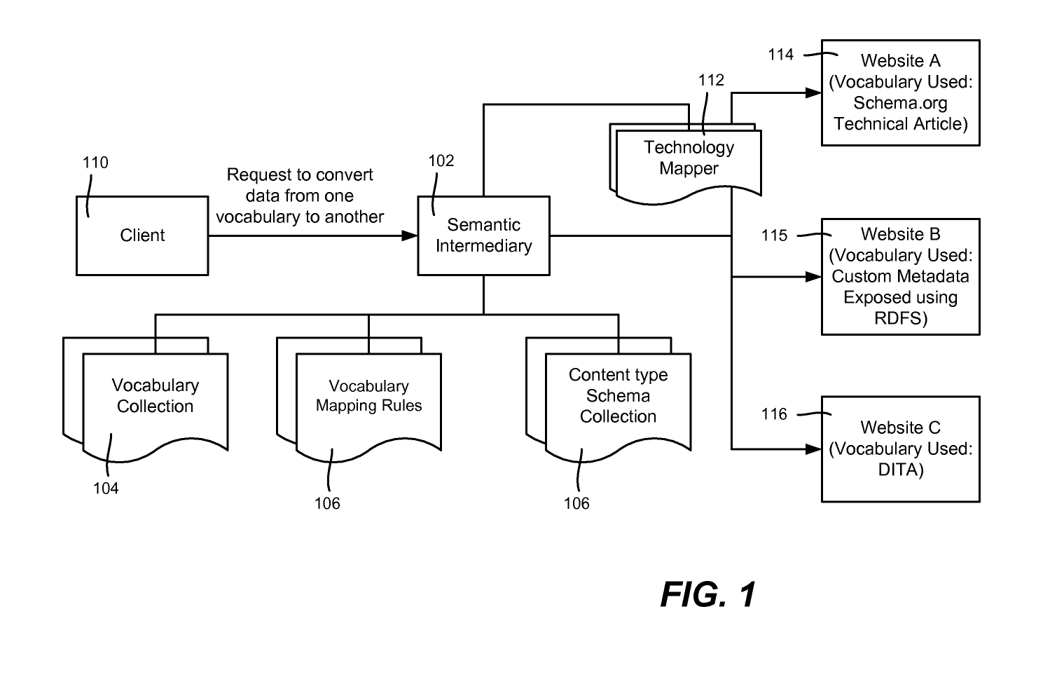

FIG. 1 shows an example implementation in which a semantic intermediary 102 develops a vocabulary collection 104 comprising a known list of vocabularies used for a domain, and vocabulary mapping rules 106 comprising a model to map from one vocabulary to another. The mappings may be constructed through one or more manual processes and/or through web site/metadata interpretations. The semantic intermediary 102 also includes and/or accesses collections of different content type schemas 108.

In FIG. 1, a client 110, such as a website developer, sends a query for some data. The metadata from the query is interpreted by the intermediary 102 to understand the vocabularies of choice or the content types that the client 110 supports. The intermediary 102, via a technology mapper 112 may send the query to data processors to retrieve data from backend services 114-116. Each data provider knows the technology used and collects the data along with the vocabulary mapped. In a translator service scenario, the input data is converted based upon the vocabulary translations rules configured in the service.

The intermediary 102 interprets the vocabulary needed for the client 110 and the vocabulary used by the data providers 114-116. To this end, the intermediary 102 may runs a set of models that interpret the element-by-element mapping, e.g., based on constraints applied in the mapping rules 106.

The intermediary applies data conversion as applicable, and fills-up data from the other data providers 114-116 based upon the mapping rules 106. The intermediary sends the data back to client 110 in a format consumable by the client 108.

FIG. 1 thus represents the taking of a client request, generating data from different sources, and leveraging the vocabulary/schema/technology mapping. For example, a client may request a “How-To” guidance topic using a tool. The tool understands the content type as defined using a schema.org technical article vocabulary. A query via the technology mapper 112 retrieves information from multiple sites (data providers 114-116), each of which may be using a different vocabulary to define How-To guidance on a specific topic. For example, one site (corresponding to data provider 115) may use a custom vocabulary defined using RDFS (Resource Description Framework Schema), while another site (corresponding to data provider 116) may use DITA based ontologies. The intermediary 102 maps the query to the data providers and sends appropriate requests to each.

The returned data is interpreted based on the vocabulary used by each site, and the data is converted to the client's known vocabulary. This process is based upon data transformation, technology interpretation and vocabulary mapping.

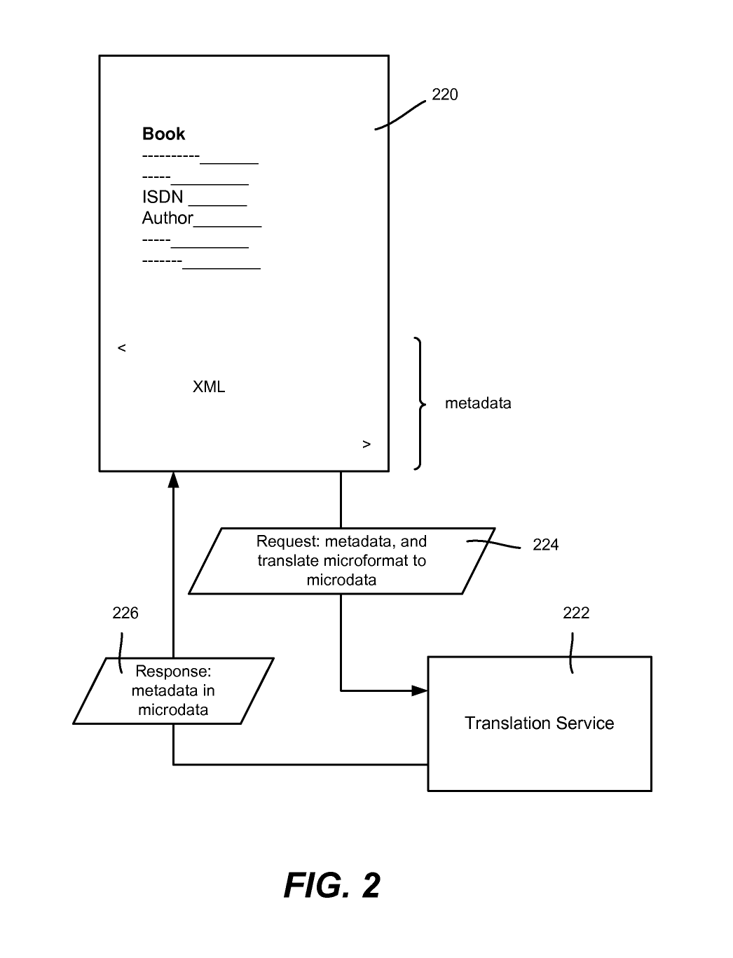

By way of another example represented in FIG. 2, consider a website corresponding to content and metadata (block 220) that is already committed to a standard vocabulary in a specific schema, e.g., rich snippet (such as using microformat), RDFa (Resource Description Framework-in-attributes), or microdata. The website as a client may pass this metadata to the intermediary, operating as a translation service 222, in a request 224 for converting data to a specific output vocabulary.

In the example of FIG. 2, a website passes its metadata (the website may send the entire page 220), represented as XML in a first format such as microformat, to the intermediary operating as the service 222, with the request 224 that specifies returning data in a second format, such as microdata format. As can be readily appreciated, any suitable first format may be provided, and any suitable second format returned.

The service 222 translates between schemas, and returns a response 226 including metadata in microdata format to the website. The mapping rules 106 (FIG. 1) may be invoked as part of the translation. In this way, the intermediary 102 converts the metadata to the appropriate format and sends the data back. The website may include this converted information in a web page or its web services.

As a further part of the translation, the service 222 may translate using different ontologies for different domains. For example, the term “magazine” in a commercial domain may be translated to “journal” in an academic domain, and vice-versa. The request may specify domain information, and/or the service may recognize the domain information from the metadata or the website that sends the request or the targeted user or application.

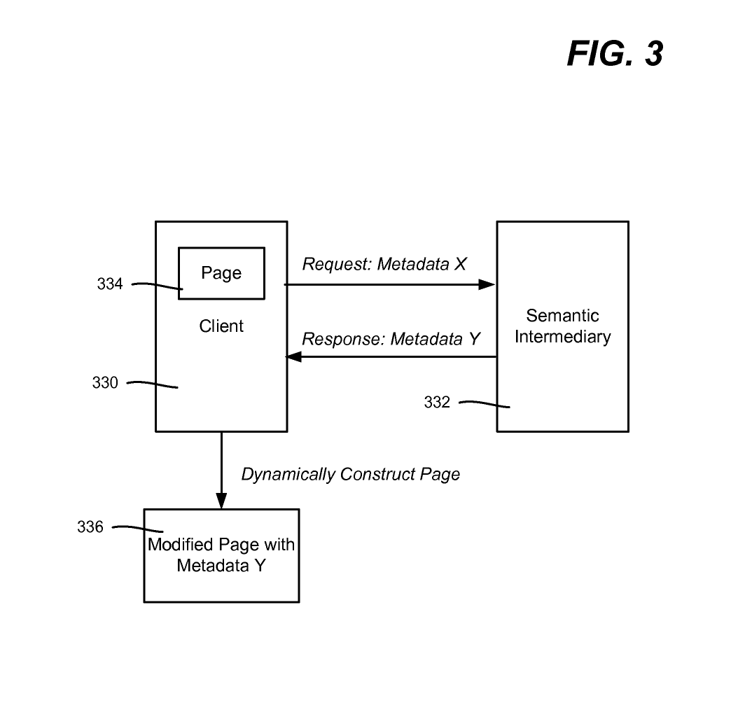

In one alternate scenario generally exemplified in FIG. 3, a website (client 330) that is committed to a certain schema language (e.g., rich snippets or RDFA, for example), passes this metadata in format/vocabulary “X” to a semantic intermediary 332 that corresponds to a page 324. In response, the intermediary returns metadata in format/vocabulary “Y” to the client 330.

The client 330 takes the response from the intermediary 332 and dynamically incorporates at least some of the metadata in format/vocabulary “Y” into a modified web page 336. As can be readily appreciated, this allows websites to continue to use one metadata language (e.g., RDFA), while being able to expose that metadata in an alternative language such as schema.org, or potentially expose the metadata in both languages. This transformation may happen during page construction in a Web server or during the page rendering in a browser or application. During page construction, the transformation to appropriate vocabulary metadata may be controlled by the Web content owner. If during page rendering, the transformation intermediary service understands the end user capabilities and requirements and can decide on the vocabulary transformation.

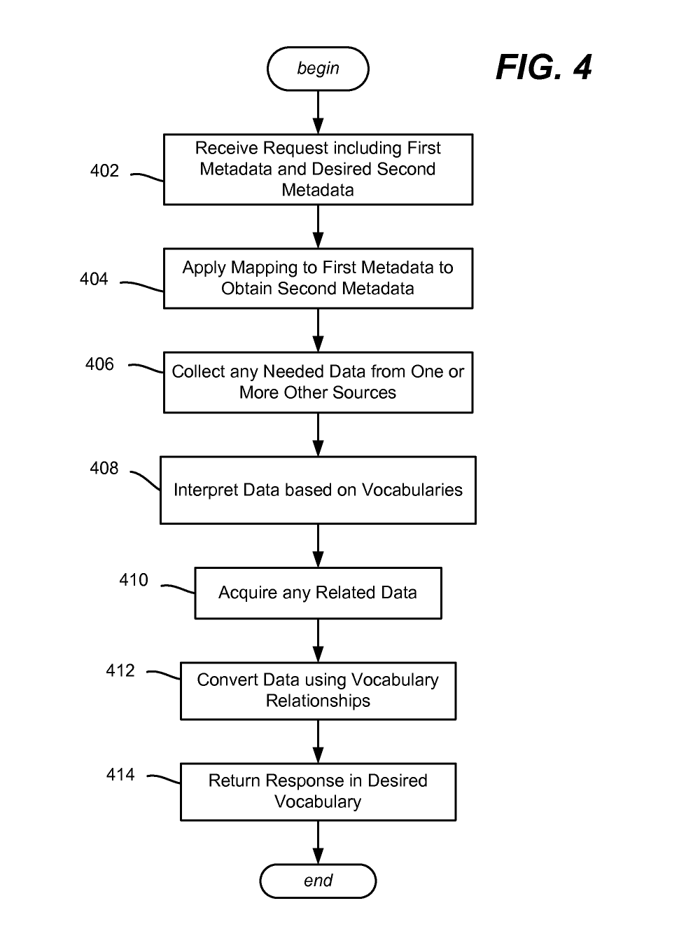

FIG. 4 is a flow diagram summarizing a process of taking a client request, leveraging the vocabulary/schema/technology mapping and converting to data using another vocabulary. In general, the intermediary manages the vocabulary mapping and presents the data in a format known to the end user.

To this end, as represented in FIG. 4, the intermediary (e.g., the translation service 222) knows a well-known set of vocabularies, and upon receiving a request (step 402) associated with first metadata and specifying second metadata. At step 404, the intermediary applies a mapping from one vocabulary to another, which may include collecting data (step 406) from one or more different sources, interpreting the data based on vocabularies (step 408), acquiring any related data (step 410). At step 412 the intermediary may convert data following the vocabulary relationships, and at step 414 sends data back to the requesting client user following a vocabulary the requesting client user is able to understand.

As can be seen, there is provided a common layer that understands different vocabularies in the Web and maps the data into appropriate vocabulary through semantic interpretation on the similarity of the vocabulary and/or the interpretation on terms' relationships. Instead of interpreting the vocabulary at each of possibly many various end user applications, which would mean that the many end users/applications need to understand the known vocabularies, associated mappings, and technology choices so as to interpret the data, the intermediary executes the semantic mapping based on known vocabularies.

In this way, any website that is already committed to a standard vocabulary in a specific schema (e.g., rich snippet or RDFa) may pass this metadata to the intermediary with a request for converting data to a specific output vocabulary. The intermediary converts the metadata to the appropriate format and sends an appropriate response back. The website may include this converted information in a Web page or Web services, including possibly dynamically modifying a web page to include the metadata in the other format.

### Example Operating Environment

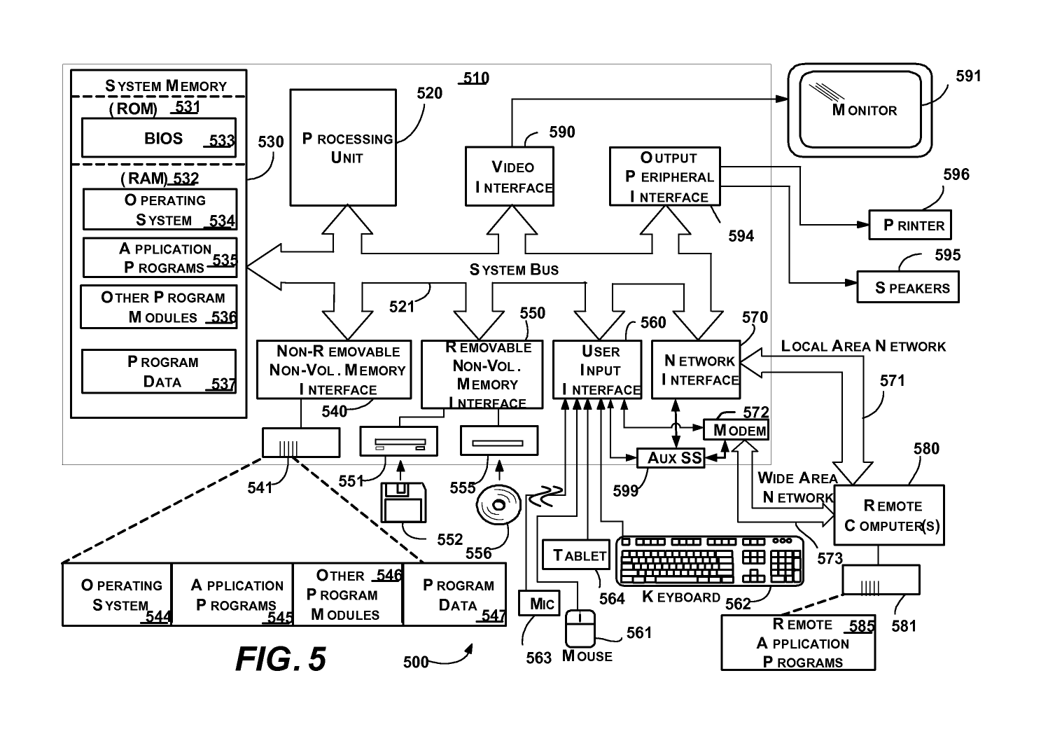

FIG. 5 illustrates an example of a suitable computing and networking environment 500 into which the examples and implementations of any of FIGS. 1-4 may be implemented, for example. The computing system environment 500 is only one example of a suitable computing environment and is not intended to suggest any limitation as to the scope of use or functionality of the invention. Neither should the computing environment 500 be interpreted as having any dependency or requirement relating to any one or combination of components illustrated in the example operating environment 500.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 5, an example system for implementing various aspects of the invention may include a general purpose computing device in the form of a computer 510. Components of the computer 510 may include, but are not limited to, a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 510 typically includes a variety of computer-readable media. Computer-readable media can be any available media that can be accessed by the computer 510 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 510. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536 and program data 537.

The computer 510 may also include other removable/non-removable, volatile/nonvolatile computer storage media. By way of example only, FIG. 5 illustrates a hard disk drive 541 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556 such as a CD ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540, and magnetic disk drive 551 and optical disk drive 555 are typically connected to the system bus 521 by a removable memory interface, such as interface 550.

The drives and their associated computer storage media, described above and illustrated in FIG. 5, provide storage of computer-readable instructions, data structures, program modules and other data for the computer 510. In FIG. 5, for example, hard disk drive 541 is illustrated as storing operating system 544, application programs 545, other program modules 546 and program data 547. Note that these components can either be the same as or different from operating system 534, application programs 535, other program modules 536, and program data 537. Operating system 544, application programs 545, other program modules 546, and program data 547 are given different numbers herein to illustrate that, at a minimum, they are different copies. A user may enter commands and information into the computer 510 through input devices such as a tablet, or electronic digitizer, 564, a microphone 563, a keyboard 562 and pointing device 561, commonly referred to as mouse, trackball or touch pad. Other input devices not shown in FIG. 5 may include a joystick, game pad, satellite dish, scanner, or the like. These and other input devices are often connected to the processing unit 520 through a user input interface 560 that is coupled to the system bus, but may be connected by other interface and bus structures, such as a parallel port, game port or a universal serial bus (USB). A monitor 591 or other type of display device is also connected to the system bus 521 via an interface, such as a video interface 590. The monitor 591 may also be integrated with a touch-screen panel or the like. Note that the monitor and/or touch screen panel can be physically coupled to a housing in which the computing device 510 is incorporated, such as in a tablet-type personal computer. In addition, computers such as the computing device 510 may also include other peripheral output devices such as speakers 595 and printer 596, which may be connected through an output peripheral interface 594 or the like.

The computer 510 may operate in a networked environment using logical connections to one or more remote computers, such as a remote computer 580. The remote computer 580 may be a personal computer, a server, a router, a network PC, a peer device or other common network node, and typically includes many or all of the elements described above relative to the computer 510, although only a memory storage device 581 has been illustrated in FIG. 5. The logical connections depicted in FIG. 5 include one or more local area networks (LAN) 571 and one or more wide area networks (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the user input interface 560 or other appropriate mechanism. A wireless networking component 574 such as comprising an interface and antenna may be coupled through a suitable device such as an access point or peer computer to a WAN or LAN. In a networked environment, program modules depicted relative to the computer 510, or portions thereof, may be stored in the remote memory storage device. By way of example, and not limitation, FIG. 5 illustrates remote application programs 585 as residing on memory device 581. It may be appreciated that the network connections shown are examples and other means of establishing a communications link between the computers may be used.

An auxiliary subsystem 599 (e.g., for auxiliary display of content) may be connected via the user interface 560 to allow data such as program content, system status and event notifications to be provided to the user, even if the main portions of the computer system are in a low power state. The auxiliary subsystem 599 may be connected to the modem 572 and/or network interface 570 to allow communication between these systems while the main processing unit 520 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method comprising, receiving a request for semantic-related metadata in a second vocabulary, the request including semantic-related metadata in a first vocabulary, translating the semantic-related metadata in the first vocabulary to semantic-related metadata in the second vocabulary, and returning the semantic-related metadata in the second vocabulary in response to the request.

2. The method of claim 1 wherein receiving the request comprises receiving the request at an intermediary web service comprising a vocabulary translator.

3. The method of claim 1 wherein receiving the request comprises receiving the request in association with at least some web page content.

4. The method of claim 1 wherein translating the semantic-related metadata comprises accessing a vocabulary collection.

5. The method of claim 1 wherein translating the semantic-related metadata comprises accessing vocabulary mapping rules.

6. The method of claim 1 wherein translating the semantic-related metadata comprises accessing a content type schema collection.

7. The method of claim 1 further comprising, using the semantic-related metadata in the second vocabulary to dynamically modify a web page or a web service response.

8. The method of claim 1 wherein the second vocabulary corresponds to microformat, RDFa (Resource Description Framework-in-attributes), or microdata.

9. A system comprising, one or more processors and memory, the memory including instructions that when executed on the one or more processors correspond to a semantic intermediary, the semantic intermediary configured to receive a request for data associated with one vocabulary, and to access mapping rules and a vocabulary collection to convert at least some of the data in the one vocabulary to data in another vocabulary and to return the data in the other vocabulary in response to the request.

10. The system of claim 9 wherein the semantic intermediary is associated with a technology mapper configured to retrieve data from one or more backend services.

11. The system of claim 9 wherein the semantic intermediary is configured to access a schema collection for schema translation.

12. The system of claim 11 wherein the one vocabulary corresponds to a defined schema or a custom schema.

13. The system of claim 12 wherein the defined schema comprises schema.org or Darwin Information Typing Architecture (DITA).

14. The system of claim 9 wherein the request for data associated with one vocabulary comprises microformat metadata.

15. The system of claim 9 wherein the request for data associated with one vocabulary comprises microdata metadata.

16. The system of claim 9 wherein the request for data associated with one vocabulary corresponds to Resource Description Framework Schema (RFDA)-based metadata.

17. The system of claim 9 wherein the request for data associated with one vocabulary corresponds to a Darwin Information Typing Architecture (DITA)-based ontology.

18. The system of claim 9 wherein the data in the other vocabulary is used to dynamically modify a web page.

19. One or more computer-readable media having computer-executable instructions, which when executed perform steps, comprising, requesting translation of web content-related metadata in one format to another format, receiving web content-related metadata in the other format in response to the request, and using the web content-related metadata in the other format to produce web-content related output.

20. The one or more computer-readable media of claim 19 wherein using the web content-related metadata in the other format to produce web-content related output comprises dynamically modifying a web page to include at least some of the web content-related metadata in the other format.
